(19) United States
(12) Patent Application Publication
(10) Pub. No.: US 2003/0076313 A1
(43) Pub. Date: Apr. 24, 2003

(54) Display apparatus

(75) Inventors: Kiyotaka Minato, Utsunomiya-shi (JP); Satoshi Tamaoki, Sendai-shi (JP)

Correspondence Address: ARMSTRONG,WESTERMAN & HATTORI, LLP, 1725 K STREET, NW, SUITE 1000, WASHINGTON, DC, 20006, US

(73) Assignee: LAB.SPHERE CORPORATION, Sendai-shi (JP)

(21) Appl. No.: 10/302,833

(22) Filed: Nov. 25, 2002

Related U.S. Application Data
(63) Continuation of application No. 09/530,413, filed on May 1, 2000, now abandoned.
Application No. 09/530,413 is a 371 of international application No. PCT/JP99/04647, filed on Aug. 27, 1999.

(30) Foreign Application Priority Data
Sep. 1, 1998 (JP) 247399/1998
Aug. 9, 1999 (JP) 225784/1999

(51) Int. Cl. G09G 5/00

(52) U.S. Cl. 345/204

(57) ABSTRACT

This invention relates to a display apparatus, comprised of: a display portion 11 consisting of a plurality of light-emitting elements (11a) equipped on a substrate so as to form a display region in a predetermined shape; a drive portion (12) that makes each light-emitting element illuminate; a control portion (13) that controls the drive portion; a power supply portion (16) that supplies electric power to the drive portion and the control portion; and a switch portion (17) with the function of turning on and off the power from the power supply portion to the drive portion, and to the control portion, based on operation instructions: having a semi-translucent cover (11c) of ample size to encompass the entire display region of the display portion; having the light-emitting elements of the display portion arranged in such a way that the light can be brightened gradually from one end of the display region toward the other end thereof, either by the increasing intensity of light emission or by the increasing density of the light-emitting elements thereof; and thereby the control portion puts the drive portion under control to make the light-emitting elements illuminate one after another from one end of the display region to the other end thereof repeatedly in a predetermined time interval.

### TECHNICAL FIELD

The present invention relates to a display apparatus that is used, for example, to indicate and lead to evacuation routes in the event of a disaster, or to show the direction to a specific destination as a navigator or to a particular location at a construction site, etc.

### BACKGROUND TECHNOLOGIES

Conventionally, emergency lights installed at emergency exits have been used as one of the disaster prevention measures in buildings, etc. Such emergency lights are generally placed above emergency exit doors, being maintained to operate uninterruptedly; backup power supply is to maintain the uninterrupted operations thereof should a power outage occur.

However, it is very difficult to recognize these emergency exit lights in the presence of smoke near the ceiling in the event of fire since the smoke is likely to flow in the area of the lights, thus reducing the perceptibility of the emergency exit.

Aside from the field of the emergency lights, guide lights have been well known, for example, for their function to navigate pedestrians, etc., at a construction site; despite the fact that such guide lights are maintained to operate uninterruptedly, however, they sometimes fail to stand out sufficiently, and are overlooked on occasion.

In connection with the above, an object of the present invention is to provide a display apparatus with higher perceptibility by means of making the display dynamically luminous, and thus ensuring it to stand out more than otherwise.

### SUMMARY OF THE INVENTION

From one aspect of the present invention, which attains the above object, there is provided a display apparatus, which is constructed to have: a display portion consisting of a plurality of light-emitting elements equipped on a substrate so as to form a display region in a predetermined shape; a drive portion that makes each light-emitting element illuminate; a control portion that controls the drive portion; a power supply portion that supplies electric power to the drive portion and the control portion; and a switch portion with the function of turning on and off the power from the power supply portion to the drive portion, and to the control portion, based on operation instructions: to have a semi-translucent cover of ample size to encompass the entire display region of the display portion; to have the light-emitting elements of the display portion arranged in such a way that the light can be brightened gradually from one end of the display region toward the other end thereof, by the increasing intensity of light emission of the lighte-mitting elements thereof; and therby the control portion puts the drive portion under control to make the light-emitting elements illuminate one after another from one end of the display region to the other end thereof repeatedly in a predetermined time interval.

According to the above-mentioned construction, the light-emitting elements of the display portion are preferably arranged such that they form a plurality of columns perpendicular to the direction, in which one end of the display region extends out to the opposite end thereof, wherein the intensity of light emission thereof gradually increases from one end of the display region to its opposite end.

From another aspect of the present invention, there is also provided a display apparatus, which is constructed to have: a display portion with a plurality of light-emitting elements equipped on a substrate so as to form a display region in a predetermined shape; a drive portion that makes each light-emitting element illuminate; a control portion that controls the drive portion; a power supply portion that supplies electric power to the drive portion and the control portion; and a switch portion with the function of turning on and off the power from the power supply portion to the drive portion, and to the control portion, based on operation instructions: to have a semi-translucent cover of ample size to encompass the entire display region of the display portion; to have the light-emitting elements of the display portion arranged in such a way that the light can be brightened gradually from one end of the display region toward the other end thereof, by the increasing density of the light-emitting elements thereof; and thereby the control portion puts the drive portion under control to make the light-emitting elements illuminate one after another from one end of the display region to the opposite end thereof repeatedly in a predetermined time interval.

According to the above-mentioned construction, the light-emitting elements of the display portion are preferably arranged such that they form a plurality of columns perpendicular to the direction, in which one end of the display region extends out to the opposite end thereof, wherein the distances between each adjacent set of the columns thereof are gradually shortened from one end of the display region toward the other.

Preferably, the inner surfaces, which face the substrate, of the cover, of the display apparatus according to the present invention are finished as roughened surfaces.

The above-mentioned display region of the display apparatus according to the present invention is preferably formed in an arrow-like shape.

The above-mentioned light-emitting elements of the display apparatus according to the present invention are preferably made by the light-emitting diodes.

Preferably, the above-mentioned cover of the display apparatus according to the present invention is comprised of semi-translucent boards, and there is provided a plate around the cover in a hue that allows the cover to stand out.

Preferably, at the back surfaces of the above-mentioned substrate of the display apparatus according to the present invention, there is formed a light-inducing portion, whose side parts and bottom part form a display region; at one end of the light-inducing portion, there is provided a flash lamp that emits light inwardly; and there is provided a flash lamp drive portion that receives an electric power from the power supply portion; where the flash lamp drive portion makes the flash lamp emit light in a predetermined time interval.

The above-mentioned substrate of the display apparatus according to the present invention is preferably comprised of semi-translucent materials such as acrylic boards, etc.

The bottom part of the above-mentioned light-inducing portion of the display apparatus according to the present invention is preferably formed such that the height thereof becomes gradually shorter in relation to the substrate from one end of the display region toward the opposite end thereof.

The bottom part of the above-mentioned light-inducing portion of the display apparatus according to the present invention is preferably formed as a mirror surface; and further preferably, the side parts of the light-inducing portion are formed as mirror surfaces, as well.

The side parts of the above-mentioned light-inducing portion of the display apparatus according to the present invention are preferably finished as roughened surfaces.

Preferably, the above-mentioned switch portion of the display apparatus according to the present invention is automatically operated via operation instructions.

Preferably, the operation instructions of the display apparatus according to the present invention are either by detection signals from various internal sensors built in thereto, by detection signals from various external sensors attached thereto, or by command signals from external systems attached thereto.

According to the above-mentioned construction, the drive portion controls the control portion so as to drive each light-emitting element in the display region, whereby light-emitting elements light up in sequence from one end of the display region toward the opposite end thereof. In this case, the display region of the display portion as a whole lights up in sequence from one end toward the opposite end, wherein the light gains more and more optical intensity as it moves from one end to the other. Therefore, the light will be dynamically shown in sequence from one end of the display region to the opposite end with increasing its optical intensity, thereby a very outstanding light display can be achieved, and ensure high perceptibility.

Therefore, if the display apparatus according to the present invention is adopted as, for example, a guide light to an emergency exit, or a guide light at a construction site, etc., it will serve as an easy-to-recognize display without being overlooked do to the optically brightened light display with its dynamic directional movement.

In the case where the light-emitting elements of the display portion are arranged in such a way that the intensity of light emission increases from one end of the display region to its opposite end thereof, light-emitting elements of higher intensity of light emission are to light up in sequence, so the apparatus can be viewed so that the light itself becomes brighter as it moves along the direction of movement.

On the other hand, in the case where the light-emitting elements of the display portion are arranged in such a way that the density increases from one end of the display region to its opposite end thereof, the number of light-emitting elements in a unit area will increase as well, so the greater number of light-emitting diodes emit light in sequence, so the apparatus could be formed so that the light appears to become-brighter as it goes in the direction of movement.

If the inner surfaces, which face the substrate, of the cover, are finished as roughened surfaces, the light emitted from each light-emitting element and reaching the inner surfaces of the cover is reflected diffusely by the inner surfaces of the cover being finished as roughened surfaces, thus the entire cover is perceived as lighting up uniformly, which provides higher perceptibility.

If the display region is formed in an arrow-like shape, the direction can be indicated by the arrow-like shape as a whole along with the light display by the movement and increasing intensity of the light-emitting elements, thus the guided destination to, for example, an emergency exit, etc. can be perceived even more clearly.

In the case where the light-emitting elements are comprised of light-emitting diodes, and if they are, for example, green LED's, the resulting display will be the same as using the emergency exit light, yet it can achieve higher perceptibility in the event of a fire as well, and as an auxiliary emergency light, it can indicate an evacuation route to an emergency exit clearly.

If the cover is comprised of semi-translucent boards, for example, green semitransparent boards, even when no light-emitting elements are turned on over the display region, the display region as a whole will appear green, since the cover itself is green. This can provide high perceptibility even in the event of a fire, and at the same time, as an auxiliary emergency light, it can indicate an evacuation route to an emergency exit clearly.

If a hue for a plate surrounding the cover is chosen to allow the cover to stand out, the perimeter of the cover will be rimmed by the palte in this hue, thus the display region of the display portion can stand out from its surroundings, which provides an easy-to-recognize display.

If on the back surfaces of the substrate, there is a light-inducing portion formed, whose side and bottom parts form a display region; at one end of the light-inducing portion, there is a flash lamp provided that emits light inwardly; and there is a flash lamp drive portion provided that receives an electric power from the power supply portion; where the flash lamp drive portion makes the flash lamp emit light in a predetermined time interval, the entire display region lights up in a glint of flash, in addition to the light display of the light-emitting elements of the display portion. Therefore, if the user looks for the display apparatus, for example, he or she can locate the display apparatus easily by the glint of flash of the flash lamp, and thereafter or simultaneously the light-emitting elements provide a light display, allowing him or her to perceive, for instance, the direction of an evacuation route.

If the substrate is comprised of semi-translucent materials such as acrylic boards, glints of flash generated on the back of the substrate by the flash lamp can be also recognized from the front of the display apparatus, thus even clearer glints of flash can be achieved.

If the bottom part of the light-inducing portion is formed with a taper in that the height thereof becomes gradually shorter in relation to the substrate from one end of the display region to the other end thereof, when light generated from the flash lamp proceeds to the opposite end while being reflected at the bottom part of the light-inducing portion as well as the back surface of the substrate, the light will be effectively lead to the opposite end, providing a sufficient intensity of light emission at the other end as well.

If the bottom part of the light-inducing portion is formed as a mirror surface, when the flash lamp generates glints of flash, the reflection efficacy of the glints of flash being reflected on the bottom part of the light-inducing portion is improved, so the light is effectively concentrated and lead to the opposite end of the display region while reiterated reflection processes, thus the entire display region can provide glints of flash of a more uniform luminous energy.

If the side parts of the above-mentioned light-inducing portion are formed as mirror surfaces, glints of flash generated by the flash lamp will undergo a total reflection on the side parts of the light-inducing portion, so the luminous energy of the incident light rays from the light-inducing portion to the back surface of the substrate will increase, thus the light is effectively concentrated and lead to the other end of the display region while reiterated reflection processes, thus the entire display region can provide glints of flash of an increased luminous energy.

If the side parts of the above-mentioned light-inducing portion are finished as roughened surfaces, glints of flash generated by the flash lamp will be diffusely reflected on the side parts of the light-inducing portion, and the glints of flash are shown on the side parts of the light-inducing portion. Thus, as the perimeter of the display region stands out in a clear relief, the shape of the display region can be observed clearly.

In the case where the above-mentioned switch portion is manually operated, an operator, etc. can operate the switch portion, if necessary, to let the light-emitting elements and the flash lamp generate light. In the case where the switch portion is automatically operated by operation instructions given as detection signals from various internal sensors built in to the display apparatus, external sensors attached thereto, or as command signals, etc. from external systems attached thereto, when, for example, a smoke sensor or a temperature sensor detects smoke or temperature in the event of a fire, or a human body sensor detects a human's presence, these detection signals will automatically operate the switch portion by turning on the switch portion, if necessary, and let the light-emitting elements and flash lamp generate light.

### BRIEF DESCRIPTION OF THE DRAWINGS

The present invention will be understood more fully from the detailed description given hereinbelow and from the accompanying drawings of the preferred embodiments of the invention, which, however, should not be taken to be limitative to the invention, but are for explanation and understanding only.

In the drawings:

FIG. 1 is a perspective view of one embodiment of a display apparatus according to the present invention;

FIG. 2 is a block diagram showing the electric configuration of the display apparatus shown in FIG. 1.

FIG. 3 is an enlarged perspective view of the display portion of the display apparatus shown in FIG. 1;

FIG. 4 is a cross-sectional view of the display portion shown in FIG. 3;

FIG. 5 is a perspective view of another embodiment of a display apparatus according to the present invention; and

FIG. 6 is a block diagram showing the electric configuration of the display apparatus shown in FIG. 5.

### BEST MODES FOR CARRYING OUT THE INVENTION

Preferred embodiments of the present invention are described in the following, with occasional references being made to the attached drawings. The forms of implementation explained in the following do not cover the techniques of the present invention comprehensively, but exemplify embodiments to implement the present invention; thus, it is self-evident for any person skilled in the art that a wide variety of variations and conversions, and amendments or deletions of the configuration are conceivable.

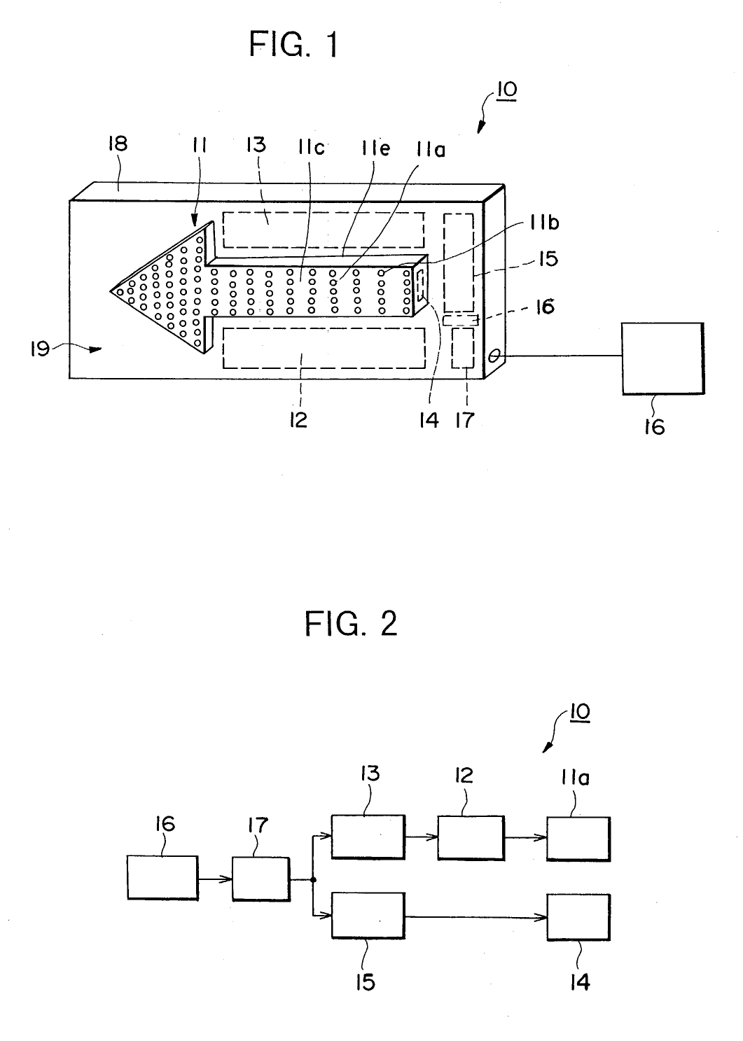

FIGS. 1 to 4 show an embodiment of a display apparatus according to the present invention.

As shown in FIGS. 1 and 2, the display apparatus 10 includes: a display portion 11 consisting of a plurality of light-emitting elements, which are light-emitting diodes 11b in the drawings, equipped on a substrate 11a; a drive circuit 12 making each light-emitting diode 11b on the display portion 11 illuminate; a control circuit 13 controlling the drive circuit 12; a flash lamp 14 placed on one side of the display portion 11, which is in the shown diagram placed on the right-hand side of the display portion; a flash lamp drive circuit 15 making the flash lamp 14 illuminate; a power supply portion 16 supplying drive voltage to the drive circuit 12, the control circuit 13 and the flash lamp drive portion 15; and a switch portion 17 turning on and off the power to the control circuit 13 and the flash lamp drive portion 15.

Here, the individual components 11 to 17 are placed in a flat body 18, and to the region, which can be obtained by removing the display portion 11 on the top side from the body 18, is attached a plate 19 with a hue that allows the display portion 11 to stand out; for example, a white plate is attached to the region.

The above-mentioned display portion 11 has a substrate 11a forming a predetermined shape, which is an arrow-shaped form in the shown diagram, and a cover 11c that covers the substrate 11a entirely on its top. The cover 11c is comprised of semi-translucent materials, where the inner surfaces facing the substrate 11a are preferably finished as roughened surfaces; and in the case, for example, of a display apparatus with green light-emitting diodes 11b, the cover 11c is also to be comprised of green semi-translucent boards, being maintained with a predetermined distance apart from the substrate 11a by inserting a spacer 11d, etc.

Moreover, the substrate 11a of the display portion 11 has on its reverse side a light-inducing portion 11e having side parts and a bottom part, which surround the bottom part of the substrate 11a. Here, the light-inducing portion 11e is preferably formed with a taper such that the height thereof becomes gradually shorter in relation to the substrate 11a moving from the right to the left, as shown in FIG. 4. And the light-inducing portion 11e is constructed in such a way that the bottom part and the side parts are finished as mirror surfaces.

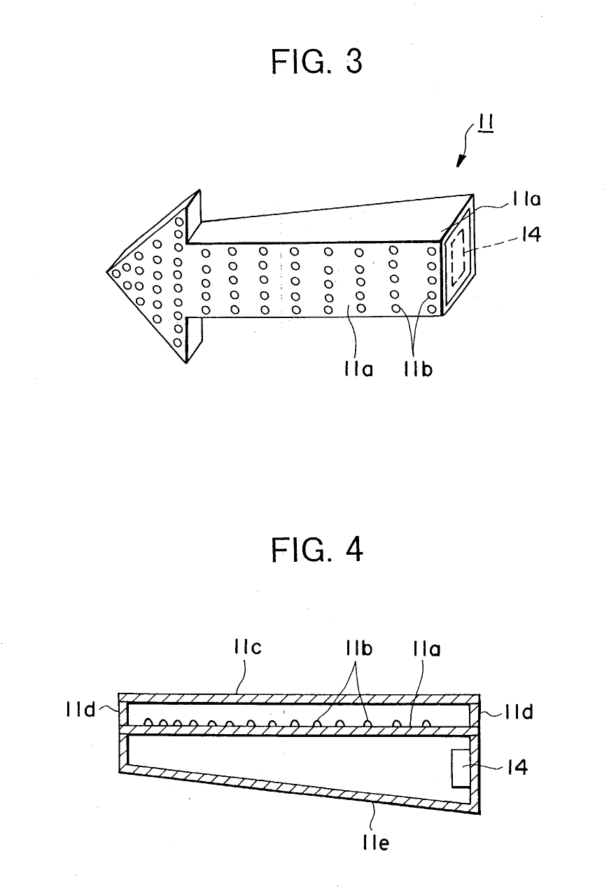

Each light-emitting diode 11b in the display portion 11 is, for example, either green, red, blue, or a combination of the preceding three colors, and arranged in such a way that the density thereof increases from one end to the other; in the case of the shown example in FIGS. 1 and 3, moving from right to left. To be more specific, individual light-emitting diodes 11b are to have an intensity of light emission equal to each other; to be arranged so as to form a plurality of columns; in the case of the shown example in FIG. 1, a plurality of columns perpendicular to the direction are going from the far right end to the far left end; and to be arranged so that the distance between each set of adjacent columns becomes gradually shorter from the far right end to the far left end.

The above-mentioned drive circuit 12 is to make each light-emitting diode 11b illuminate by applying drive voltage thereto. And the control circuit 13 is to control the drive circuit 12 to make each light-emitting diode 11b illuminate one after another in the order from the ones at the far right end to those at the far left end repeatedly in a predetermined time interval.

The above-mentioned flash lamp 14 is, as shown in FIGS. 3 and 4, to be placed at the far right end of the display portion 11, and to emit light toward the inner part of the light-inducing portion 11e. The flash lamp drive circuit 15 is, based on the drive voltage from the power supply portion 16, to generate high voltage by, for example, charging capacitors, and to make the flash lamp 14 generate glints of flash by discharging thus generated high voltage instantaneously in a predetermined time interval.

The above-mentioned power supply portion 16 is constructed to obtain direct current voltage of a predetermined voltage by, as is publicly known, transforming and smoothing commercial power by means of a transformer, etc.

Furthermore, the power supply portion 16 could be comprised of various batteries such as dry cells, chargeable batteries, etc. as well, and it could employ a combination of commercial power and dry cells. In the case where a combination of both types is used, a switching device or other electric methods could be used to alternate commercial power and cells back and forth, and when commercial power is used, chargeable batteries, which are used as cells, could be charged by the provided commercial power.

The above-mentioned switch portion 17 is to turn on and off the power supply from the power supply portion 16 to the drive circuit 12, the control circuit 13, and the flash lamp drive portion 15; ordinary manual or electric switches are to be employed.

Furthermore, the switch portion 17 could be operated automatically upon receiving external operation instructions. In this case, operation instructions could be detection signals from various sensors such as a temperature sensor, smoke sensor, etc., regardless of whether they are built-in sensors incorporated to the display apparatus 10 or external devices; or command signals from fire alarms or external systems such as disaster-preventive systems or building monitoring systems, etc.

The above-mentioned plate 19 is comprised of a plastic plate with a hue that makes the perimeter of the display portion 11 stand out; for example, when the display portion 11 is green, the plate could be a plastic board in white, yellow, etc. Thus, in case a plate with a hue that makes the cover 11c stand out is provided arount the cover 11c, the perimeter of the cover is to be rimmed by the plate 19, and the display region of the display portion 11 stands out from its surroundings; thus, an easy-to-recognize display can be achieved.

The display apparatus 10 according to this embodiment of the present invention is comprised as described above; when using the display apparatus 10, the user first needs to operate the switch portion 17 to turn it on. Consequently, electric power is supplied from the power supply portion 16 into the drive circuit 12, the control circuit 13, and the flash lamp drive circuit 15.

Subsequently, the control circuit 13 controls the drive circuit 12, whereby each light-emitting diode 11b in the display portion 11 is driven; the light-emitting diodes 11b extending vertically in each column in FIGS. 1 and 3 emit light simultaneously; and such columns light up in sequence from the right to the left. In this case, the light emitted from each light-emitting diode 11 is to be diffused on the inner surfaces of the cover 11c, since they are finished as roughened surfaces, a larger area over the surface of the cover 11c lights up eventually.

Consequently, the light-emitting diodes 11b light up in sequence from the right to the left side. Since the density of the light-emitting diodes 11b is arranged such that it becomes gradually higher from the right to the left, the optical brightness gradually increases as well. Furthermore, since the distances between the columns of light-emitting diodes 11b gradually become shorter and shorter from the right to the left, the display lights up at a slower velocity as it moves from the right-hand side to the left.

At the same time, the flash lamp drive circuit 15 drives the flash lamp 14, whereby the flash lamp 14 generates glints of flash in a predetermined time interval. Consequently, inside the light-inducing portion 11e, the glints of flash from the flash lamp 14 are reflected on the side parts and the bottom part of the light-inducing portion 11e, and the back surface of the substrate 11a, wherein light will be lead to the left-hand side more effectively since the height of the bottom part of the light-inducing portion 11e gradually becomes shorter and shorter from the right to the left-hand side.

Therefore, the glints of flash from the flash lamp 14 will proceed to the inner part of the light-inducing portion 11e entirely, and then emitted outwardly from the substrate 11a to the outside via the cover 11c, whereby the glints of flash will be displayed on the entire cover 11c.

As described above, the display apparatus 10 according to the present invention can provide a movement of the light-emitting diodes 11b from the right to the left-hand side, an increase in intensity of light emission associated with the movement, and a changing velocity of the movement, whereby the directionality of the display can be emphasized, and the glints of flash by the flash lamp 14 can clearly indicate the location of the display apparatus 10.

Consequently, when using the display apparatus 10 as an auxiliary emergency light for indicating an evacuation route to an emergency exit, for example, the user can easily identify the display apparatus 10 by the glints of flash of the flash lamp 14 even under the presence of smoke which makes the display apparatus 10 difficult to be perceived, and can easily recognize the evacuation route by the movement of the green light in the display portion 11, as well as by the changing intensity and velocity of light emission.

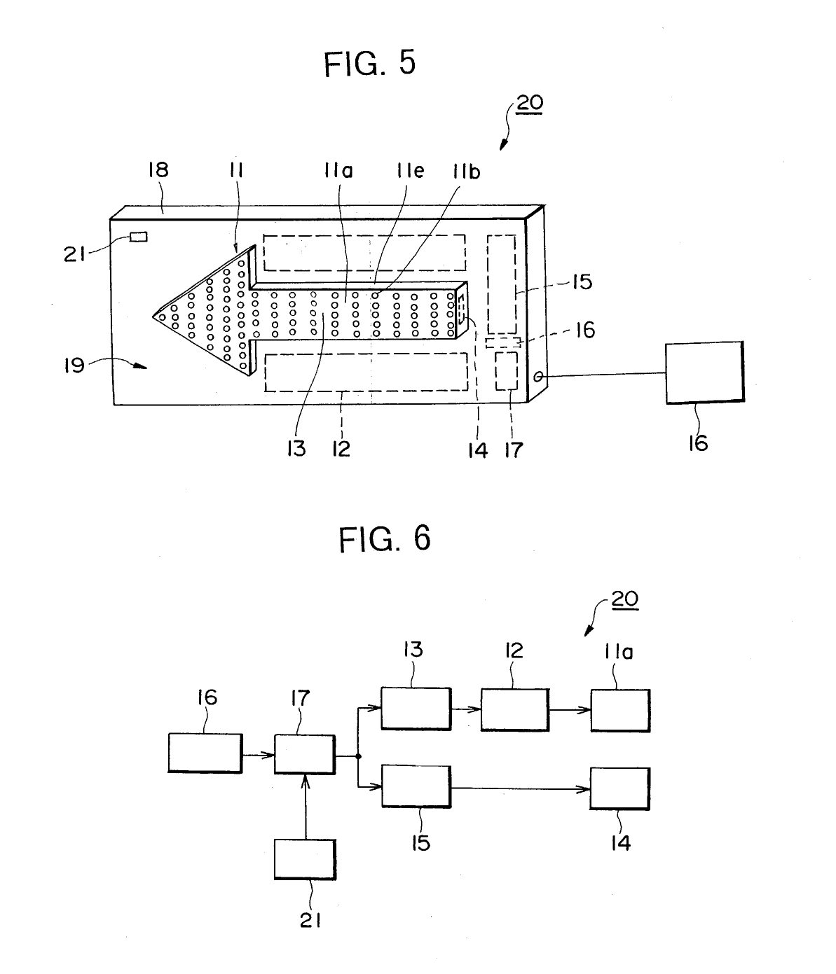

FIGS. 5 and 6 show another embodiment of a display apparatus according to the present invention.

The display apparatus 20 shown in FIG. 5 is constructed generally in the same manner as the display apparatus 10 in the above; however, it is differently constructed in the following.

Firstly, the display apparatus 20 is constructed where the light-emitting diodes 11b in the display portion 11 are arranged, as shown in FIG. 5, in such a way that their intensity of light emission increases gradually from the right to the left-hand side.

To be more specific, each light-emitting diode 11b is arranged so as to form a plurality of vertical columns in FIG. 5, and each set of adjacent columns are kept at an equal distance apart from each other, and light-emitting diodes of greater intensity of light emission are used as it moves from the right to the left-hand side.

Next, in the display apparatus 20, the light-inducing portion 11e is constructed in such a way that the side parts are finished as not mirror surfaces but roughened surfaces, and that light from the flash lamp 14 can be emitted outwardly from the side parts of this light-inducing portion 11e.

Moreover, the display apparatus 20 is equipped with a sensor 21 on the white plate 19, for example.

This sensor 21 does not necessarily have to be mounted on the white plate 19, and could be placed around the body 18 or externally.

The sensor 21 could be, for example, a smoke sensor or a temperature sensor, which detects smoke or an increase in temperature in the event of a fire, and thus generates detection signals.

In this case, the switch portion 17 is constructed in such a way that it automatically turns on and off, interpreting the detection signals from the above-mentioned sensor 21 as operation instructions, in addition to or in place of the manual operations thereof.

When using the display apparatus 20 having such an embodiment, the user first needs to operate on the switch portion 17 to turn it on, or detection signals from the sensor 21 automatically operates to turn it on. Consequently, electric power is supplied from the power supply portion 16 to the drive circuit 12, the control circuit 13 and the flash lamp drive circuit 15.

Subsequently, the control circuit 13 controls the drive circuit 12, whereby each light-emitting diode 11b in the display portion 11 is driven; the light-emitting diodes 11b extending vertically in each column emit light simultaneously; and such columns light up in sequence from the right to the left-hand side. In this case, the light emitted from each light-emitting diode 11b is to be diffused on the inner surfaces of the cover 11c, since they are finished as roughened surfaces, a larger area over the surface of the cover 11c lights up eventually.

Consequently, the light-emitting diodes 11b light up in sequence from the right to the left-hand side. Since the intensity of light emission of the light-emitting diodes 11b is arranged such that it becomes gradually higher from the right to the left, brightness also gradually increases.

At the same time, the flash lamp drive circuit 15 drives the flash lamp 14, whereby the flash lamp 14 generates glints of flash in a predetermined time interval. Consequently, inside the light-inducing portion 11e, the glints of flash from the flash lamp 14 are reflected on the side parts and bottom of the light-inducing portion 11e, and the back surface of the substrate 11a, wherein light will be lead to the left-hand side more effectively since the height of the bottom part of the light-inducing portion 11e gradually becomes shorter and shorter from the right to the left-hand side.

Therefore, the glints of flash from the flash lamp 14 will proceed to the inner part of the light-inducing portion 11e entirely, and then emitted outwardly from the substrate 11a to the outside via the cover 11c, whereby the glints of flash will be displayed on the entire cover 11c; and the glints of flash are emitted diffusely from the side parts of the light-inducing portion 11e, whereby the perimeter of the display region of the display portion 11 is illuminated.

Thus, the display apparatus 10 according to the second embodiment can provide a movement of the light-emitting diodes 11b from the right to the left-hand side and an increase in brightness associated with the movement, whereby the directionality of the display can be emphasized, and the glints of flash by the flash lamp 14 can clearly indicate the location of the display apparatus 10.

Consequently, when using the display apparatus 10 as an auxiliary emergency light for indicating an evacuation route to an emergency exit, for example, in the event of fire, the switch portion 17 will be automatically turned on based on detection signals from the sensor 21, so the user can easily identify the display apparatus 10 by the glints of flash of the flash lamp 14 and the illumination of the perimeter even under the presence of smoke which normally makes the display apparatus 10 difficult to be perceived, can easily recognize the evacuation route by the movement and the changing brightness of the green light in the display portion 11.

In the embodiments described in the above, the change in brightness from one end of the display region to the other is actualized by change in density or intensity of light emission of the light-emitting diodes; however, this is not limited to these embodiments, and change in the drive voltage of the light-emitting diodes could actualize the same effect as well, and combinations of these means can attain even more extensive change in brightness.

Furthermore, the first embodiment described in the above places the light-emitting diodes so that their density can change, while the second embodiment places them so that their intensity of light emission can change; in either case, however, the only requirement in the construction is that the light-emitting diodes change their brightness, for example, by means of a change in density or intensity of light emission of the light-emitting diodes, etc.

Moreover, the first embodiment described in the above has the light-inducing portion 11e with its side parts being finished as mirror surfaces, while the second embodiment has the light-inducing portion 11e with its side parts being finished as roughened surfaces; however, as is obvious, this is not limited to these embodiments, and these could be constructed differently as well.

Furthermore, either embodiment described in the above has both the flash lamp 14 and the flash lamp drive circuit 15; however, it is not limited to these embodiments, but they could be omitted and the lighting display by the light-emitting diodes 11b alone could suffice.

And the second embodiment shown in the above has the switch portion 17, which could be automatically operated by interpreting detection signals from the sensor 21 as operation instructions; however, it is not limited to this, but could be automatically operated by interpreting instructions signals from fire alarms, etc. or command signals, etc. from disaster-preventive systems, building monitoring systems, etc., as operation instructions.

Likewise, either embodiment shown in the above has the display portion 11 formed in an arrow-like shape; however, it is not limited to this, but various other shapes, other characters or symbols; although a dynamic light display is achieved by the movement from the right to the left; however, this could be the other way around, from the left to the right. It is certainly possible that it could be constructed moving in a vertical direction.

In addition, the examples illustrated in the above employ light-emitting diodes as light-emitting elements to be used in the present invention, but of course, incandescent bulbs could be used as well. Also, the present invention is explained with examples using mainly green light-emitting diodes; however, yellow light-emitting diodes could be suitably used as a display at a construction site, etc., red light-emitting diodes could be appropriately used for navigating pedestrians, etc. to a particular destination, and light-emitting diodes in other colors could be used in displays as various navigators, guides, etc.

Although the invention has been illustrated and described with respect to exemplary embodiments thereof, it should be understood by those skilled in the art that the foregoing and various other changes, omissions and additions may be made therein and thereto, without departing from the spirit and scope of the present invention. Therefore, the present invention should not be understood as limited to the specific embodiments set out above, but to include all possible embodiments which can be embodied within a scope encompassed and equivalents thereof with respect to the feature set out in the appended claims.

What is claimed is:

1. A display apparatus comprised of: a display portion consisting of a plurality of light-emitting elements equipped on a substrate so as to form a display region formed in a predetermined shape; a drive portion that makes each light-emitting element illuminate; a control portion that controls the drive portion; a power supply portion that supplies electric power to the drive portion and the control portion; and a switch portion with the function of turning on and off the power from the power supply portion to the drive portion, and to the control portion, based on operation instructions:
having a semi-translucent cover of ample size to encompass the entire display region of the display portion;
having the light-emitting elements of the display portion arranged in such a way that the light can be brightened gradually from one end of the display region toward the other end thereof, by the increasing intensity of light emission of the light-emitting elements thereof; and thereby,
the control portion puts the drive portion under control to make the light-emitting elements illuminate one after another from one end of the display region to the other end thereof repeatedly in a predetermined time interval.

2. A display apparatus as set forth in claim 1, further characterized in that the light-emitting elements of the display portion are preferably arranged such that they form a plurality of columns perpendicular to the direction, in which one end of the display region extends out to the other end thereof, wherein the intensity of light emission thereof gradually increases from one end of the display region toward the other end.

3. A display apparatus comprised of: a display portion consisting of a plurality of light-emitting elements equipped on a substrate so as to form a display region formed in a predetermined shape; a drive portion that makes each light-emitting element illuminate; a control portion that controls the drive portion; a power supply portion that supplies electric power to the drive portion and the control portion; and a switch portion with the function of turning on and off the power from the power supply portion to the drive portion, and to the control portion, based on operation instructions:
having a semi-translucent cover of ample size to encompass the entire display region of the display portion;
having the light-emitting elements of the display portion arranged in such a way that the light can be brightened gradually from one end of the display region toward the other end thereof, by the increasing density of the light-emitting elements thereof; and thereby,
the control portion puts the drive portion under control to make the light-emitting elements illuminate one after another from one end of the display region to the other end thereof repeatedly in a predetermined time interval.

4. A display apparatus as set forth in claim 3, further characterized in that the light-emitting elements of the display portion are preferably arranged such that they form a plurality of columns perpendicular to the direction, in which one end of the display region extends out to the other end thereof, wherein the distances between each adjacent set of the columns thereof are gradually shortened from one end of the display region toward the other end.

5. A display apparatus as claimed in any of claims 1 to 4, characterized in that the inner surfaces, which face the substrate, of the above-mentioned cover are finished as roughened surfaces.

6. A display apparatus as set forth in any of claims 1 to 4, further characterized in that the display region is formed in an arrow-like shape.

7. A display apparatus as set forth in any of claims 1 to 4, further characterized in that the light-emitting elements are light-emitting diodes.

8. A display apparatus as set forth in any of claims 1 to 4, further characterized in that the cover is comprised of semi-translucent boards.

9. A display apparatus as set forth in any of claims 1 to 4, further characterized in that there is provided a plate around the cover in a hue that allows the cover to stand out.

10. A display apparatus as set forth in any of claims 1 to 4, further characterized in that at the back surfaces of the substrate, there is formed a light-inducing portion, whose side parts and bottom part form a display region; at one end of the light-inducing portion, there is provided a flash lamp that emits light inwardly; and there is provided a flash lamp drive portion that receives electric power from the power supply portion;
where the flash lamp drive portion makes the flash lamp emit light in a predetermined time interval.

11. A display apparatus as set forth in claim 10, characterized in that the substrate is comprised of semi-translucent materials.

12. A display apparatus as set forth in claim 10, further characterized in that the bottom part of the light-inducing portion is formed such that the height thereof becomes gradually shorter in relation to the substrate from one end of the display region toward the other end thereof.

13. A display apparatus as set forth in claim 10, further characterized in that the bottom part of the light-inducing portion is formed as a mirror surface.

14. A display apparatus as set forth in claim 10, further characterized in that the side parts of the light-inducing portion are formed as mirror surfaces.

15. A display apparatus as set forth in claim 10, further characterized in that the side parts of the light-inducing portion are finished as roughened surfaces.

16. A display apparatus as set forth in any of claims 1 to 4, characterized in that the switch portion is automatically operated via operation instructions.

17. A display apparatus as set forth in claim 16, characterized in that the operation instructions are by detection signals from various internal sensors built in thereto.

18. A display apparatus as set forth in claim 16, further characterized in that the operation instructions are by detection signals from various external sensors attached thereto.

19. A display apparatus as set forth in claim 16, further characterized in that the operations instructions are by command signals from external systems.
